(19) United States
(12) Patent Application Publication
(10) Pub. No.: US 2026/0349660 A1
(43) Pub. Date: Nov. 5, 2026

(54) AI-Powered Curator Engine for Translating Stakeholder Input into Structured Technical Requirements

(71) Applicants: Michael Myers, Tucson, AZ (US); James Betsch, DuPont, WA (US)

(72) Inventors: Michael Myers, Tucson, AZ (US); James Betsch, DuPont, WA (US)

(21) Appl. No.: 19/276,966

(22) Filed: Jul. 22, 2025

Related U.S. Application Data
(60) Provisional application No. 63/797,871, filed on Apr. 30, 2025.

(51) Int. Cl. G06F 8/10; G06F 40/197

(52) U.S. Cl. CPC G06F 8/10; G06F 40/197

(57) ABSTRACT

A system and method for translating multi-role stakeholder input expressed in natural language into structured, traceable technical requirements using a configurable Curator Engine. The system includes role-specific stakeholder interfaces, an AI-assisted curator engine for parsing and categorization, and an event-sourced Requirements Store for immutable lineage. A role-specific dashboard provides filtered real-time requirement status. The system supports multiple domains through external configuration files, enabling domain-agnostic deployment.

### 4. BACKGROUND

This invention relates to collaborative software development and requirements management, particularly systems that automate translation of stakeholder inputs into developer-ready requirements with immutable traceability. Existing ALM and requirements tools do not bridge the communication gap between diverse stakeholder roles (e.g., program managers, end users, developers). They lack automated translation of plain-language inputs, lineage tracking, and real-time stakeholder-specific feedback mechanisms. This results in ambiguity, rework, and poor audit readiness.

### 5. BRIEF SUMMARY OF THE INVENTION

The invention introduces a Curator Engine and supporting components to:
Capture plain-language inputs via role-specific interfaces.
Parse and classify input into requirement elements.
Weight and prioritize elements using stakeholder-specific profiles.
Generate Canonical Requirement Objects (CROs) with immutable metadata.
Store CROs in an event-sourced, version-controlled Requirements Store.
Display CROs via stakeholder dashboards tailored to user roles.

The system is domain-agnostic and supports reconfiguration without software changes.

### 6. BRIEF DESCRIPTION OF THE DRAWINGS

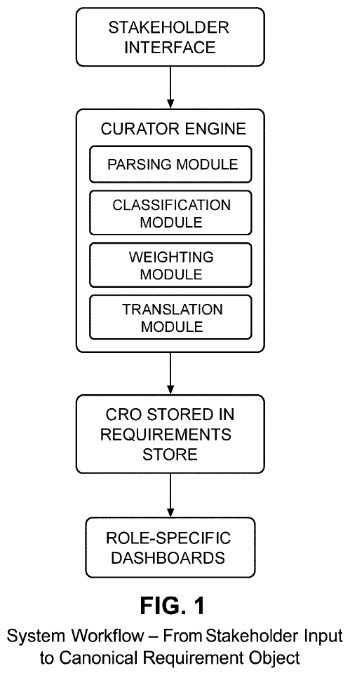

6.1. FIG. 1—System Workflow: A flowchart illustrating the process from stakeholder input to display: (1) Stakeholder Interface receives input; (2) Curator Engine processes the input via NLP parsing, classification, weighting, lineage tagging, and translation; (3) CROs are stored in the Requirements Store; (4) Role-specific dashboards display status and outputs.

### 7. DETAILED DESCRIPTION OF THE INVENTION

### 7.1. System Components

### 7.1.1. Stakeholder Interfaces

Role-specific web interfaces dynamically generated from external JSON configuration files. They include tailored question sets and weighting rules.

### 7.1.2. Curator Engine

Parsing Module: Extracts requirement elements using NLP.
Classification Module: Categorizes as functional, non-functional, etc.
Weighting Module: Applies stakeholder weighting profiles.
Lineage Module: Assigns immutable metadata to each input.
Translation Module: Converts processed input into CROs.

In certain embodiments, the Curator Engine may incorporate natural language models to aid in disambiguation or identify input requiring clarification. 7.1.3. Requirements Store

An event-sourced database with version control, enabling rollback, event replay, and traceability. The Requirements Store may expose events to external systems via configurable integration interfaces. 7.1.4. Dashboards

Stakeholder-specific dashboards render CROs, status updates, and relevant metrics. Dashboards subscribe to event updates from the Requirements Store. In some embodiments, dashboards may display clarification statuses, compliance indicators, or SLA-based alerts based on CRO state.

### 7.2. Method Overview

1. Stakeholder submits input via tailored interface.
2. Curator Engine parses and classifies the input.
3. Consideration weights applied based on role.
4. CRO is generated with lineage data.
5. CRO is stored and versioned.
6. Dashboards display real-time status.

### 7.3. Example Use Case (Abbreviated)

A city administrator enters input on visibility needs. The Curator Engine processes this input and generates a CRO with defined KPIs, stores it with timestamp and source metadata, and surfaces it to relevant dashboards. This allows audit-ready traceability and removes the need for status meetings.

### 7.4. Enabling Material

This application is supported by examples of stakeholder configurations and domain profiles sufficient to enable implementation across Smart City and DoD environments. These illustrative materials can be provided upon request or incorporated in future filings.

1. (System Claim): A system for translating stakeholder input into technical requirements, comprising:
stakeholder interfaces receiving natural language input;
a curator engine comprising parsing, classification, weighting, lineage, and translation modules;
a requirements store with event-sourced version control;
dashboards rendering role-specific views of stored requirements.

2. (Method Claim): A method for translating stakeholder input into structured requirements, comprising:
receiving natural language input;
extracting and categorizing elements;
applying stakeholder weighting;
generating CROs with lineage data;
storing CROs in version-controlled format;
displaying CROs through stakeholder dashboards.

3. (Computer-Readable Medium): A non-transitory computer-readable medium storing instructions that, when executed, cause a processor to:
accept natural language input;
parse, classify, and apply weighting;
generate CROs with immutable metadata;
store CROs;
display filtered views based on stakeholder role.
